(19) United States
(12) Patent Application Publication
(10) Pub. No.: US 2009/0218385 A1
(43) Pub. Date: Sep. 3, 2009

(54) WIRE BONDER

(75) Inventors: Florian Faessler, Bern (CH); Thomas Fankhauser, Bern (CH); Paul Andreas Stadler, Rotkreuz (CH)

Correspondence Address: MCCORMICK, PAULDING & HUBER LLP, CITY PLACE II, 185 ASYLUM STREET, HARTFORD, CT, 06103, US

(73) Assignee: Oerlikon Assembly Equipment AG, Steinhausen, Cham (CH)

(21) Appl. No.: 12/393,184

(22) Filed: Feb. 26, 2009

(30) Foreign Application Priority Data
Feb. 29, 2008 (CH) 317/08

(51) Int. Cl. B23K 1/06

(52) U.S. Cl. 228/1.1

(57) ABSTRACT

A wire bonder comprises a bonding head with a rocker which is arranged on the bonding head and is rotatable about a horizontal axis. The rocker comprises at least three bores into which a piezoelectric element each is inserted, which element is used either as a sensor or as a piezoelectric drive in order to move a horn which is fastened to a body relative to the rocker. The body is tightly screwed onto the rocker by means of at least three screws, with at least two screws being tightly screwed in a resilient way. The body is pressed against the piezoelectric elements. A membrane is preferably arranged between the rocker and the body, which membrane prevents that shearing forces can act upon the piezoelectric elements.

### PRIORITY CLAIM

Applicant hereby claims foreign priority under 35 U.S.C §119 from Swiss Application No. 317/08 filed Feb. 29, 2008, the disclosure of which is herein incorporated by reference.

### FIELD OF THE INVENTION

The invention relates to a Wire Bonder.

### BACKGROUND OF THE INVENTION

A wire bonder is an automatic machine with which semiconductor chips are wired under the influence of pressure, ultrasonic sound and heat after their mounting on a substrate. The wire bonder comprises a capillary which is clamped at the tip of a horn. The capillary is used for fastening the wire to a connection point of the semiconductor chip and to a connection point of the substrate and for guiding the wire between the two connection points. The movement of the capillary in space occurs by means of a bonding head which is movable in the horizontal x-y plane and a rocker which is mounted on the bonding head and on which the horn is mounted and which enables the movement in the vertical z-direction.

During the production of the wire connections, the bonding head and the rocker are accelerated and braked to an extremely high extent. These strong accelerations lead to the consequence that the tip of the horn where the capillary is clamped and thus also the capillary are made to oscillate in an undesirable manner. The capillary can only be set down to the connection point when the oscillations have slowed down to a negligible amount. This causes waiting periods which prolong the bonding cycle.

A wire bonder is known from US 20060076390 in which the undesirable oscillations of the bonding head are detected by means of a sensor and are compensated by means of at least one actuator arranged between the horn and the rocker.

It is an object of the invention to improve the solution known from US 20060076390.

### BRIEF DESCRIPTION OF THE INVENTION

A wire bonder according to the invention comprises a bonding head, a rocker, a body, a horn in which a capillary can be inserted, wherein the rocker is arranged on the bonding head and is rotatable about a horizontal axis. The rocker comprises at least one bore into which a piezoelectric element is inserted. The body is tightly screwed onto the rocker by means of at least two screws, with at least two of the at least two screws being tightly screwed in a resilient way, so that the body is pressed against the piezoelectric element or the piezoelectric elements. The horn is fastened to the body, and the at least one piezoelectric element is used either as a sensor and/or as a piezoelectric drive for moving the horn relative to the rocker.

In a first preferred embodiment, the number of bores with a piezoelectric element is four and the number of screws with which the body is tightly screwed onto the rocker is at least four.

In a second preferred embodiment, the number of bores with a piezoelectric element is three and the number of screws with which the body is tightly screwed onto the rocker is at least three.

The wire bonder preferably further comprises a membrane arranged between the rocker and the body, with the membrane being fastened to the rocker on the one hand and to the body on the other hand.

The wire bonder may further comprise a resistance strain gauge fastened to one of the piezoelectric elements or to the membrane.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows the bonding head of a wire bonder;

FIG. 2 illustrates a tilting movement of the bonding head;

FIGS. 3 to 5 show a rocker and a body fastened to the rocker which is movable relative to the rocker;

FIGS. 6 to 9 show perspective views of various membranes, and FIG. 10 shows a further membrane.

### DETAILED DESCRIPTION OF THE INVENTION

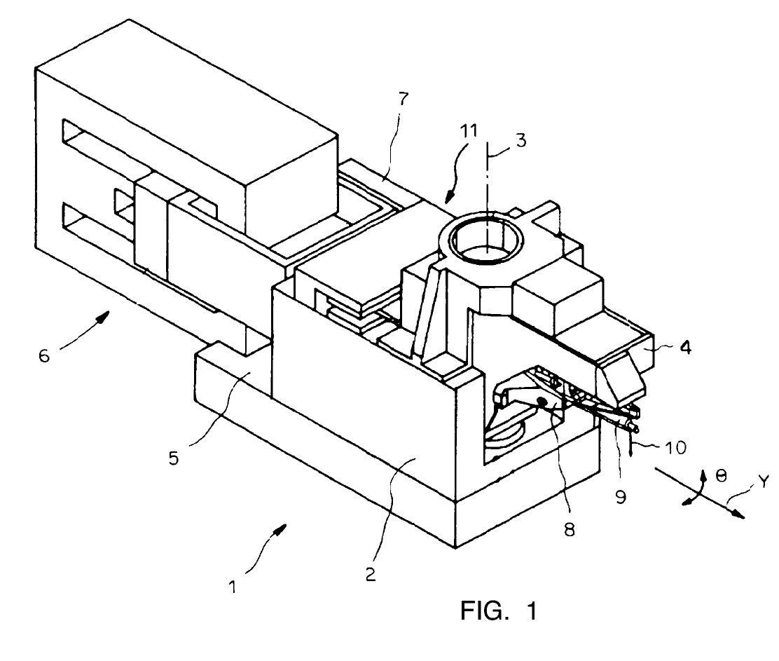

FIG. 1 schematically shows a perspective view of the bonding head 1 of a wire bonder. In this example, the bonding head 1 is a rotative bonding head which is constructed according to U.S. Pat. No. 6,460,751 and consists of a slide 2 and a rotary beam 4 which is held on the slide 2 and is rotatable about a vertical axis 3. The wire bonder comprises a horizontally aligned glide plate 5, a first drive 6 and a bearing element 7 for the movement of the slide 2 along a linear axis designated as the y-axis. A rocker 8 which is rotatable about a horizontal axis is held on the rotary beam 4, to which rocker a horn 9 is fastened, at the tip of which a capillary 10 is clamped which guides a wire. A second drive 11 is mounted on the slide 2 which rotates the rotary beam 4 about the vertical axis 3. The rotary beam 4 is rotatable with respect to the y-axis about an angle θ of approximately ±15°. A third drive (not visible) is mounted on the rotary beam 4, which drive rotates the rocker 8 about the horizontal axis. At the end of the horn 9 which is opposite of the capillary 10, an ultrasonic generator (not visible) is fastened which supplies the horn 9 with ultrasonic sound.

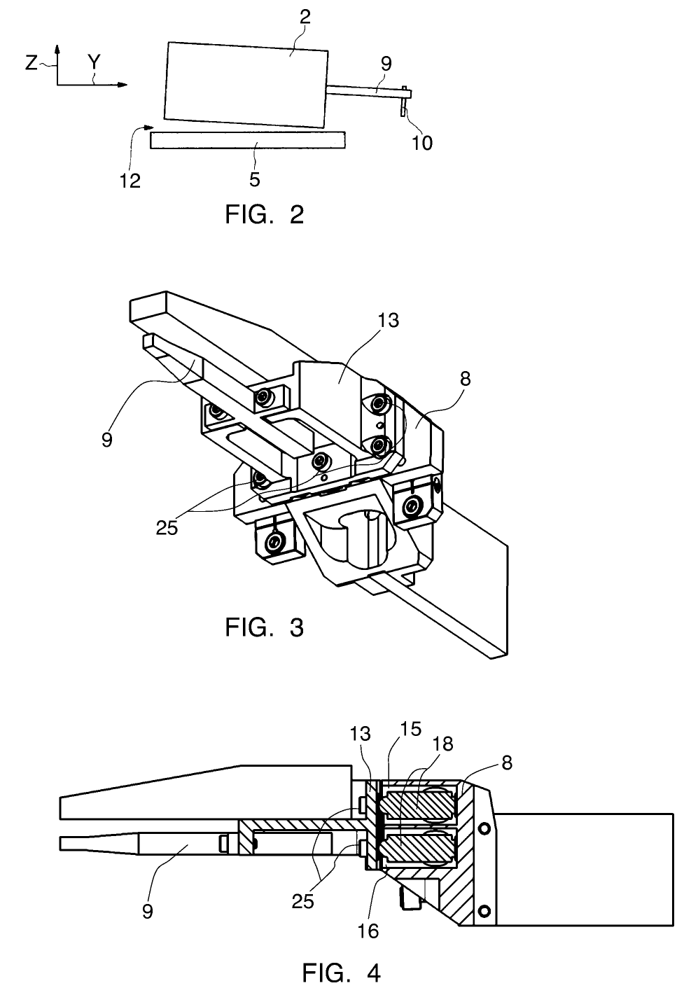

The bonding head 1 can oscillate in numerous ways. The oscillations cannot be eliminated by constructional means or only with a disproportionately high effort. In the following, a simple example is shown for an oscillation of the bonding head 1 which may occur and cause undesirable oscillations of the horn 9. The slide 2 is held on the glide plate 5 by means of air, and the rotary beam 4 is also held on the slide 2 by means of air. The stiffness of the air bearings is limited. As a result, it may occur that in the case of high acceleration the air bearing is loaded to such an extent that the dimensions of the air gap in the air bearing change temporarily. These changes are transferred to the tip of the capillary 10. This is shown in FIG. 2 by way of example and exaggeration in the case that the slide 2 which is moved at high speed in the y-direction is suddenly braked very strongly. It may occur during braking for example that the bonding head 1 will tilt forward. When the acceleration occurring during braking decreases again, the bonding head 1 will tilt back again and the air gap 12 will become uniform again. This tilting movement is not perceptible by the naked eye. The loading of the air bearing usually not only leads to a simple tilting movement, but to successive tilting movements (back and forth) with decreasing amplitude, i.e. to oscillations of the slide 2. In this case, the oscillations are directed in the z-direction, i.e. in the vertical direction. Similarly, oscillations of the rotary beam 4 occur when the rotary beam 4 is accelerated strongly. The oscillations of the slide 2 and the rotary beam 4 are transferred to the horn 9. Undesirable oscillations also occur when a bearing other than an air bearing is used.

In order to eliminate the oscillations of the horn 9, additional actuators are provided between the horn 9 and the rocker 8, as in US 20060076390, which actuators can provide very small paths very quickly. Horn 9 is fastened to a body 13 which is movable relative to rocker 8 by means of the actuators, so that the tip of the capillary 10 fastened to the horn 9 can perform small movements in all three spatial directions.

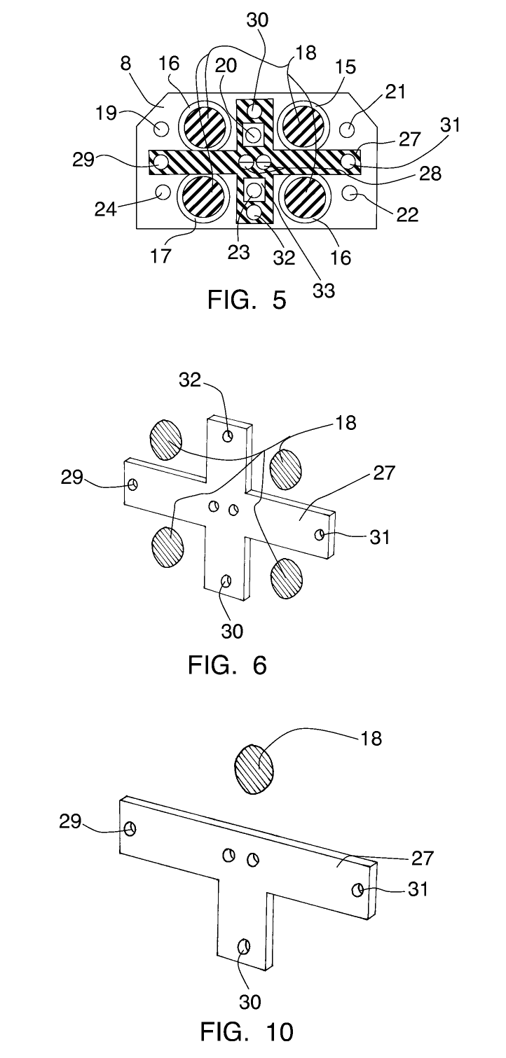

FIGS. 3 to 5 show a preferred solution in which piezoelectric elements are used as actuators. FIG. 3 shows the rocker 8 and the body 13 in a perspective view. FIG. 4 shows the rocker 8 and the body 13 in a longitudinal sectional view along the line I-I of FIG. 5. FIG. 5 shows a top view of the side of the rocker 8 facing the body 13.

The side of the rocker 8 facing the body 13 contains a plurality of bores which are used for various purposes. In a first embodiment, four bores 14 to 17 each receive a piezoelectric element which is designated below as a piezoelectric drive 18. The centers of the four bores 14 to 17 form a rectangle. The piezoelectric drives 18 are preferably cast in the pertinent bore with a heat-conducting, rubber-like casting compound in order to dissipate the heat occurring during operation. If required, cooling elements can also be provided in order to actively cool the piezoelectric drives 18. The piezoelectric drives 18 protrude from the bores 14 to 17 and touch the body 13. Four, preferably six, further bores 19 to 24 are arranged in two rows of three bores each in such a way that the center of the first bore 14 is disposed between the two bores 19 and 20, the center of the second bore 15 between the two bores 20 and 21, the center of the third bore 16 between the two bores 22 and 23, and the center of the fourth bore 17 between the two bores 23 and 24. Body 13 is fastened in a resilient way to rocker 8 with at least four screws 25 which are screwed into the bores 19, 21, 22 and 24. Preferably, the body 13 is resiliently fastened to the rocker 8 by means of six screws 25 which are screwed into the bores 19 to 24. The side of the body 13 which faces the rocker 8 rests on all four piezoelectric drives 18. Tightly screwed in a resilient way shall mean according to a first preferred variant that the body 13 is fastened with conventional screws to the rocker 8, which screws are screwed into the four bores 19, 21, 22 and 24 or the six bores 19 to 24, and that a spring, such as a disk spring 26 for example, is inserted between the head of the screws 25 and the body 13, and means according to a second variant that the body 13 is fastened to the rocker 8 by means of four or six reduced-shaft bolts (in German: Dehnschrauben) which are screwed into the four bores 19, 21, 22 and 24 or the six bores 19 to 24. A reduced-shaft bolt is a screw in which the shaft of the bolt tapers at a predetermined point until slightly below the diameter of the root of the thread, so that it is able to take up alternating loads in an elastic manner. In both variants, the screws are tightened during mounting to such an extent that the body 13 exerts a force on the four piezoelectric drives 18: The four piezoelectric drives 18 are pretensioned.

In the example, the rocker 8 and the body 13 are screwed together by means of six reduced-shaft bolts or by means of six conventional screws and six disk springs 26. Although this solution is the optimal solution, it is also possible to use reduced-shaft bolts only in the two middle bores 20 and 23 or only to use a disk spring in the screws engaging in the two middle bores 20 and 23, and to use conventional screws in the other bores. It is similarly possible to omit the middle bores 20 and 23 and the respective screws.

The piezoelectric drives 18 are sensitive to shearing forces, i.e. they can be damaged or even destroyed by shearing forces. In order to prevent this, the piezoelectric drives 18 are provided on the side facing the body 13 with a spherical head on the one hand. On the other hand, a membrane 27 is advantageously arranged between the body 13 and the rocker 8, which membrane is fastened both to the rocker 8 as well as to the body 13. Membrane 27 does not touch the piezoelectric drives 18. In the example, the membrane 27 comprises two bores in the center which are opposite of respective bores of the rocker 8, so that the membrane 27 can be fastened to the rocker 8 by means of screws 28. These bores in the rocker 8 are applied in the center between the four bores 14 to 17. Membrane 27 further comprises four bores 29 to 32 at the periphery which are opposite of respective bores of the body 13, so that the membrane 27 can be fastened to the body 13 by means of screws. To ensure that the assembly of the rocker 8, the membrane 27 and the body 13 is possible in the described manner, the rocker 8 and/or the body 13 are provided with respective continuous bores or recesses, so that the screws are accessible during assembly. FIG. 5 shows two such recesses 33 of the membrane 27. On the other hand, it is also possible to fasten the center of the membrane 27 to the body 13 and the rocker 8 to the periphery of the membrane 27.

Membrane 27 is a two-dimensional structure which, as illustrated, can be cross-shaped. It is the task of the membrane 27 to join the rocker 8 and the body 13 with each other in such a way that the body 13 is unable to move relative to the rocker 8 in the plane opened up by the two-dimensional membrane 27, but that the piezoelectric drives 18 can locally change the distance between the body 13 and the rocker 8.

The piezoelectric drives 18 come with the property that they change their length over time through loading caused by pretensioning. In order to detect such changes it is advantageous to stick a resistance strain gauge on the longitudinal side of at least one piezoelectric drive 18, and preferably on all of them. An alternative solution is to stick at least one resistance strain gauge on the membrane 27. The output signal of the resistance strain gauge or the output signals of the resistance strain gauges are used to measure the effective length of the piezoelectric drives 18 and to monitor the same accordingly and, if necessary, to recalibrate the same.

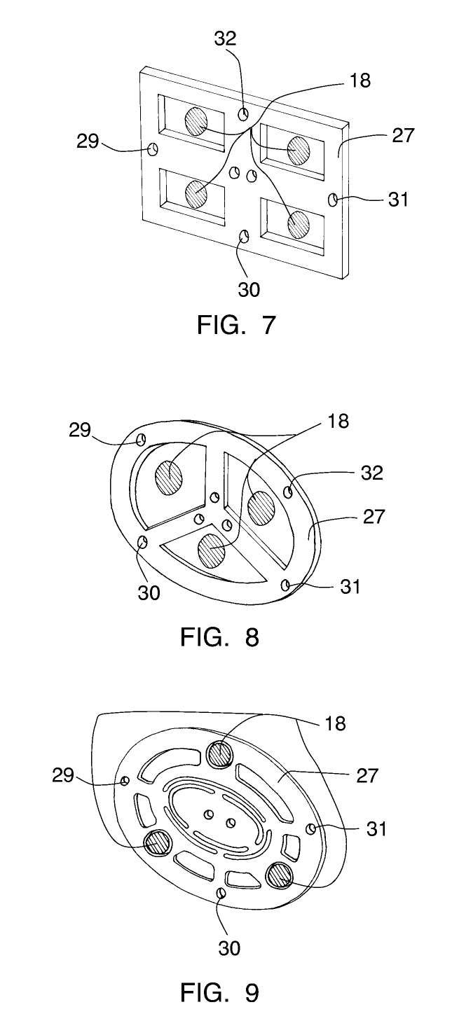

FIG. 6 shows a perspective view of the membrane 27 with two bores in the center, so that the membrane 27 can be fastened by means of the screws 28 (FIG. 5) to the rocker 8, and with the bores 29 to 32, so that the membrane 27 can be fastened to the body 13 (FIG. 4). For the sake of better clarity, FIG. 6 shows the position of the four piezoelectric drives 18. FIG. 7 shows a further possible form of the membrane 27.

The described embodiment has four piezoelectric drives 18 which are used to swivel the body 13 relative to the rocker 8 in two directions extending orthogonally with respect to each other. The same swiveling possibilities can also be achieved with only three piezoelectric drives 18. FIGS. 8 and 9 show two embodiments of membranes 27 which are designed for a solution with three piezoelectric drives 18. The membranes 27 shown in FIGS. 7 to 9 contain several recesses.

FIG. 10 shows a perspective view of a membrane 27 in the case that the body 13 needs to be swivelable relative to the rocker 8 in only one single direction. The membrane 27 contains the two bores in the center, so that the membrane 27 can be fastened to the rocker 8 by means of the screws 28 (FIG. 5), and three bores 29 to 31, so that the membrane 27 can be fastened to the body 13 (FIG. 4). The body 13 is fastened with at least two screws in a resilient manner to the rocker 8.

The described solution with the piezoelectric drives 18 is characterized by the following features:
The body 13 and the rocker 8 form a part of the bonding head with a very high stiffness.
The piezoelectric drives 18 allow dynamic movements of the body 13 relative to the rocker 8 in a frequency range of 0 (DC) up to approximately 3000 Hz, wherein the movement in the longitudinal direction of the horn 9 can be between 1 μm and approximately 20 μm.
The piezoelectric drives 18 are pretensioned in the example to such an extent that their operating point lies in a deflection of approximately 5 μm.

The described coupling between the rocker 8 and the body 13 by means of the membrane 27 comes with the advantage that laterally directed movements of the body 13 are not transferred to the rocker 8 and vice-versa, which means that the laterally directed relative movements are completely decoupled. This coupling protects the piezoelectric drives 18 from undesirable shearing forces, which applies both in the case when the piezoelectric drives 18 are used as actuators, as in the present case, and also when piezoelectric elements are used as sensors instead of the piezoelectric drives 18, or when the piezoelectric elements comprise both a piezoelectric drive as well as a piezoelectric sensor.

The invention is not limited to the bonding head described in this application. It can be used with any arbitrary bonding head of any arbitrary wire bonder. The terms “screw” and “screwing” shall include any equivalent means and/or type of securing that allows the required alignment.

1. A wire bonder, comprising
a bonding head,
a rocker,
a body,
a horn in which a capillary can be inserted,
wherein
the rocker is arranged on the bonding head and is rotatable about a horizontal axis,
the rocker comprises at least one bore into which a piezoelectric element is inserted,
the body is tightly screwed onto the rocker by means of at least two screws, with at least two of the at least two screws being tightly screwed in a resilient way, so that the body is pressed against the piezoelectric element or the piezoelectric elements,
the horn is fastened to the body, and
the at least one piezoelectric element is used either as a sensor and/or as a piezoelectric drive for moving the horn relative to the rocker.

2. The wire bonder according to claim 1, further comprising a membrane arranged between the rocker and the body, with the membrane being fastened to the rocker on the one hand and to the body on the other hand.

3. The wire bonder according to claim 1, further comprising a resistance strain gauge fastened to one of the piezoelectric elements or to the membrane.

4. The wire bonder according to claim 2, further comprising a resistance strain gauge fastened to one of the piezoelectric elements or to the membrane.

5. The wire bonder according to claim 1, wherein the number of bores with a piezoelectric element is three and wherein the number of screws with which the body is tightly screwed onto the rocker is at least three.

6. The wire bonder according to claim 2, wherein the number of bores with a piezoelectric element is three and wherein the number of screws with which the body is tightly screwed onto the rocker is at least three.

7. The wire bonder according to claim 3, wherein the number of bores with a piezoelectric element is three and wherein the number of screws with which the body is tightly screwed onto the rocker is at least three.

8. The wire bonder according to claim 4, wherein the number of bores with a piezoelectric element is three and wherein the number of screws with which the body is tightly screwed onto the rocker is at least three.

9. The wire bonder according to claim 1, wherein the number of bores with a piezoelectric element is four and wherein the number of screws with which the body is tightly screwed onto the rocker is at least four.

10. The wire bonder according to claim 2, wherein the number of bores with a piezoelectric element is four and wherein the number of screws with which the body is tightly screwed onto the rocker is at least four.

11. The wire bonder according to claim 3, wherein the number of bores with a piezoelectric element is four and wherein the number of screws with which the body is tightly screwed onto the rocker is at least four.

12. The wire bonder according to claim 4, wherein the number of bores with a piezoelectric element is four and wherein the number of screws with which the body is tightly screwed onto the rocker is at least four.
